(19) United States
(12) Patent Application Publication
(10) Pub. No.: US 2012/0307361 A1
(43) Pub. Date: Dec. 6, 2012

(54) Polarization converter made of meta material

(76) Inventors: Ruopeng Liu, Shenzhen (CN); Guanxiong Xu, Shenzhen (CN); Chunlin Ji, Shenzhen (CN); Yutao Yue, Shenzhen (CN); Zhen Liao, Shenzhen (CN)

(21) Appl. No.: 13/522,334

(22) PCT Filed: Nov. 24, 2011
(86) PCT No.: PCT/CN11/82810

§ 371 Date: Jul. 16, 2012

(30) Foreign Application Priority Data
Mar. 15, 2011 (CN) 201110061752.5
Apr. 30, 2011 (CN) 201110111506.6

(51) Int. Cl. G02B 5/30

(52) U.S. Cl. 359/485.01; 359/483.01

(57) ABSTRACT

A polarization converter made of metamaterial, including a base material and a number of artificial microstructures disposed on the base material. The artificial microstructures can influence the electric field vector of plane electromagnetic wave propagating in it. The electric field vector of the electromagnetic wave can be decomposed into two non-zero orthogonal components on one or more planes perpendicular to the incident direction of the electromagnetic wave, the orthogonal components can be parallel and perpendicular to the optical axis at the position where the artificial microstructure located. After the electromagnetic wave passing through the polarization converter made of metamaterial, the two orthogonal components have a phase difference Δθ different from before incidence, thereby achieving mutual conversion between the above electromagnetic wave polarization methods. The polarization converter made of metamaterial of the present invention is simple in structure, and can easily realize polarization conversion of electromagnetic waves.

### FIELD OF THE INVENTION

The present invention relates to the field of metamaterial, and more particular to a polarization converter made of metamaterial.

### BACKGROUND OF THE INVENTION

Polarization state of electromagnetic wave is widely used in the areas of liquid crystal display, RF antenna and various radiation devices, satellite antenna and optical devices. Traditional polarization converter normally restricts transmission of a kind of polarization wave, and reflects undesired polarization waves; or, divides a wave into two wave beams with different polarization states. In the latter situation, one polarization wave can only carry less than half energy. Therefore, it has significant energy loss and needs high level of process requirement and high cost. In addition, the conversion between circular polarization wave and linear polarization wave can be achieved by means of waveguide with gradually changed cross section. Such method has less energy loss. However, it requires high degree of machining accuracy to obtain exit wave with better polarization isolation, which is hard to be realized.

In various antennas, microwave and optical instruments, it often requires conversion between different polarization states in order to gain certain single polarization wave or dual polarization wave. The main concern of polarization conversion lies in the following aspects:

1) High performance. Polarization wave after conversion should have high degree of polarization isolation, close to the desired polarization state.

2) Low loss. It should have high energy conversion efficiency in order to save energy and reduce consumption.

3) Small size. It should not occupy too much space.

Besides, the polarization conversion method should be easy to realize. The design of it should not be too complex and the cost of device should not be too high.

Metamaterial is made up of a medium base material and a number of artificial microstructures (generally adopting metal microstructures) disposed on the base material. Metamaterial can provide many material properties that various ordinary materials have or do not have. The size of a single artificial microstructure should be in the range between 1/10 and ⅕ of a wavelength. It can have electric response and/or magnetic response to applied electric field and/or magnetic field, and thus exhibit an equivalent dielectric constant and/or equivalent permeability. The equivalent dielectric constant and equivalent permeability of artificial microstructure is determined by the parameter of geometric dimension of its unit which can be designed or controlled artificially. Furthermore, the artificial microstructure can have artificially designed anisotropic electromagnetic parameter and thus can produce plenty of novel phenomenon. This makes possible to realize polarization conversion.

### SUMMARY OF THE INVENTION

The technical problem mainly solved by the present invention is to provide a polarization converter made of metamaterial which can realize polarization conversion of electromagnetic wave easily.

In order to solve the above technical problem, one technical solution employed by the present invention is to provide a polarization converter made of metamaterial, including a base material and a number of artificial microstructures disposed on the base material. The artificial microstructures can influence the electric field vector of plane electromagnetic wave propagating in it. The electric field vector of the electromagnetic wave can be decomposed into two non-zero orthogonal components on one or more planes perpendicular to the incident direction of the electromagnetic wave. The two orthogonal components can be parallel and perpendicular to the optical axis at the position where the artificial microstructure located. After the electromagnetic wave passing through the polarization converter made of metamaterial, the two orthogonal components have a phase difference Δθ different from that before incidence, thereby achieving mutual conversion between the above electromagnetic wave polarization modes.

According to a preferred embodiment of the present invention, the electromagnetic property of a number of artificial microstructures is anisotropic. The refractive indices in the polarization converter made of metamaterial are distributed uniformly. A number of artificial microstructures are uniformly distributed on one or more planes perpendicular to the incident direction of the electromagnetic wave.

According to a preferred embodiment of the present invention, the phase difference Δθ=(k1−k2)×d, wherein

k1=ω×\sqrt{ε₁}×\sqrt{μ₁};

k2=ω×\sqrt{ε₂}×\sqrt{μ₂};

The ω is frequency of electromagnetic wave;

ε₁ and μ₁ are dielectric constant and permeability of the metamaterial unit in the direction of one of the two orthogonal components respectively. ε₂ and μ₂ are dielectric constant and permeability of the metamaterial unit in the direction of the other of the two orthogonal components respectively.

The d is the thickness of the metamaterial.

According to a preferred embodiment of the present invention, the base material is made up of a number of sheet-like substrates stacked together and parallel to each other. Each of the sheet-like substrates has a number of artificial microstructures attached thereon. The sheet-like substrate is perpendicular to the incident direction of the electromagnetic wave. All of the artificial microstructures are arranged periodically on the sheet-like substrate.

According to a preferred embodiment of the present invention, the substrate can be made of ceramic, polymer materials, ferroelectric materials, ferrite materials or ferromagnetic materials.

According to a preferred embodiment of the present invention, the phase difference Δθ=Kπ, wherein K is integral number.

According to a preferred embodiment of the present invention, the optical axis direction of the artificial microstructure and the electric field vector direction of the incident electromagnetic wave include an angle of 45 degrees.

According to a preferred embodiment of the present invention, the optical axis direction of the artificial microstructure and the electric field vector direction of the incident electromagnetic wave include a non 45 degrees angle.

According to a preferred embodiment of the present invention, the phase difference Δθ=(2K+1) (π/2), wherein K is integral number.

According to a preferred embodiment of the present invention, the optical axis direction of the artificial microstructure and the electric field vector direction of the incident electromagnetic wave include an angle of 45 degrees.

According to a preferred embodiment of the present invention, the phase difference Δθ is not equal to Kπ nor equal to (2K+1) (n/2), wherein K is integral number.

According to a preferred embodiment of the present invention, the optical axis direction of the artificial microstructure and the electric field vector direction of the incident electromagnetic wave include a non 45 degrees angle.

According to a preferred embodiment of the present invention, the artificial microstructures are metal microstructures. Each metal microstructure is wires of certain pattern attached to the sheet-like substrate. The pattern of the wires is a non 90 degrees rotational symmetric graphic.

According to a preferred embodiment of the present invention, the wires can attach to the substrate by means or etching, electroplating, drilling, photoengraving, electronic engraving or ion engraving.

According to a preferred embodiment of the present invention, the wires are copper wire or silver wire.

According to a preferred embodiment of the present invention, the wires are in the form of two dimensional snowflake shape which has a first main wire and a second main wire crossed perpendicularly to each other. Two first branch wires are disposed at two ends of the first main wire. Two second branch wires are disposed at two ends of the second main wire.

According to a preferred embodiment of the present invention, the first main wire and the second main wire bisect each other. The centers of the two first branch wires are connected to the first main wire. The centers of two second branch wires are connected at the second main wires.

According to a preferred embodiment of the present invention, the electric field vector of incident electromagnetic wave is decomposed into two orthogonal components at the line where the first main wire and the second main wire located.

According to a preferred embodiment of the present invention, the electric field vector direction of the incident electromagnetic wave and the first main wire include an angle of 45 degrees.

The beneficial effects of the present invention are as follows: different from the prior art situation, the polarization converter made of metamaterial according to the present invention influence the electric field vector of electromagnetic wave propagating in it by artificial microstructures of metamaterial so that the polarization property has been changed when the electromagnetic wave exiting the polarization converter made of metamaterial. The polarization converter made of metamaterial of the present invention is simple in structure, and has low manufacture cost and high conversion efficiency. Besides, it has multi functions and is convenient to control and design.

### BRIEF DESCRIPTION OF THE DRAWINGS

FIG. 1 is a schematic view showing structure of polarization converter made of metamaterial according to an embodiment of the present invention;

FIG. 2 is a view seen from another perspective angle of FIG. 1;

FIG. 3 is a schematic view showing metal microstructure in an embodiment of polarization converter made of metamaterial of the present invention;

FIG. 4 is a metal microstructure pattern derived from the pattern shown in FIG. 3;

FIG. 5 is a metal microstructure pattern derived from the pattern shown in FIG. 3;

FIG. 6 is another metal microstructure pattern derived from the pattern shown in FIG. 3;

FIG. 7 is a schematic view showing the polarization conversion of electromagnetic wave.

### DETAILED DESCRIPTION OF THE INVENTION

“Metamaterials” refer to some artificial composite structures or composite materials with some extraordinary physical properties that natural materials do not have. By orderly designing critical physical dimensions of the materials, the restrictions of apparent natural law can be broken, and extraordinary material functions beyond the natural inherent ordinary properties can be obtained.

“Metamaterials” have three important characteristics:

(1) “metamaterials” generally are composite materials with novel artificial structures;

(2) “metamaterials” have extraordinary physical properties (which the materials in the nature often do not have);

(3) the properties of “metamaterials” are determined by the inherent properties of its component materials and the artificial microstructures therein collectively.

As commonly known:

Electromagnetic wave has polarization property. Its polarization mode refers to linear polarization, circular polarization and elliptical polarization. As know from the principle of antenna radiation, the electromagnetic wave in free space generally takes the orientation of electric field Ē as the polarization direction of electric wave. Ē changes over time. If the trajectory of the changing endpoint of vector Ē is a line, such electromagnetic wave can be referred as a linear polarization wave. If the magnitude of Ē remains constant, but direction changes over time in a plane perpendicular to the propagation direction at the observation point, the trajectory of the changing vector endpoint is a circle, such electromagnetic wave can be referred as circular polarization wave. If both the magnitude and direction of Ē change over time, the trajectory of the changing vector endpoint is an ellipse, then such wave can be referred as elliptical polarization wave. Circular polarization and elliptical polarization can be collectively called non-linear polarization. Linear polarization has two special cases: horizontal polarization and vertical polarization.

In three dimensional space, the instantaneous electric field of electromagnetic wave propagating along z axis direction can be written as: Ē= [symbol] + [symbol] ,

If [symbol] =Exm COS(wt+θx), then [symbol] =Eym COS(wt+θy), wherein, Exm and Eym are amplitudes of the electric field in X axis direction and Y axis direction respectively; w is angular frequency of electromagnetic wave fluctuation; and, θx and θy are phases of the two components in X axis direction and Y axis direction respectively.

If the phase difference of [symbol] and [symbol] is nπ(n=1, 2, 3, . . . ), then the module of the resultant vector should be: |Ē|=(Ēₓ²+Ē_{y}²)^{1/2}=(Exm²+Eym²)^{1/2} COS wt, which is a variable that changes over time. The phase θ of the resultant vector is: θ=tg⁻¹(Ey/Ex)=tg⁻¹(Eym/Exm) which is a constant. Therefore, we can see that the trajectory of the endpoint of the resultant vector is a line.

The plane defined by Ē and propagation direction is called polarization plane. If the polarization plane is parallel to ground, the polarization is horizontal polarization. If the polarization plane is perpendicular to ground, the polarization is vertical polarization.

If [symbol] and [symbol] have the same amplitude and phase difference is (2n+1)n/2, the |Ē|=(Ēₓ²+Ē_{y}²)^{1/2}=(Exm²+Eym²)^{1/2} should be constant and the phase changes over time t: θ=tg⁻¹(Ey/Ex)=wt , so the trajectory of the resultant vector endpoint is a circle, and the polarization is called circular polarization.

Circular polarization can be classified as dextrorotation and levorotation according to the rotation direction of electric field. As seen in the propagation direction of wave, if the electric field vector rotates clockwise in cross section (conforming to the right hand rule), such polarization is called dextrorotation circular polarization. If the electric field vector rotates anticlockwise in cross section (conforming to the left hand rule), such polarization is called levorotation circular polarization. Therefore, if [symbol] is ahead of [symbol] π/2, the polarization will be dextrorotation circular polarization. If [symbol] lags behind [symbol] π/2, such polarization will be levorotation circular polarization.

If the amplitudes and phase differences of [symbol] and [symbol] do not satisfy the above conditions, that is to say, the magnitude and direction of Ē change over time (both of them are not constant), then the trajectory of result vector endpoint is an ellipse, and the polarization is called elliptical polarization. Elliptical polarization and circular polarization can be classified as dextrorotation and levorotation according to the rotation direction of electric field. As seen in the propagation direction of wave, if the electric field vector rotates clockwise in cross section, such polarization is called dextrorotation elliptical polarization. If the electric field vector rotates anticlockwise in cross section, such polarization is called levorotation elliptical polarization.

In present invention, a polarization converter is constructed by metamaterial. Specifically:

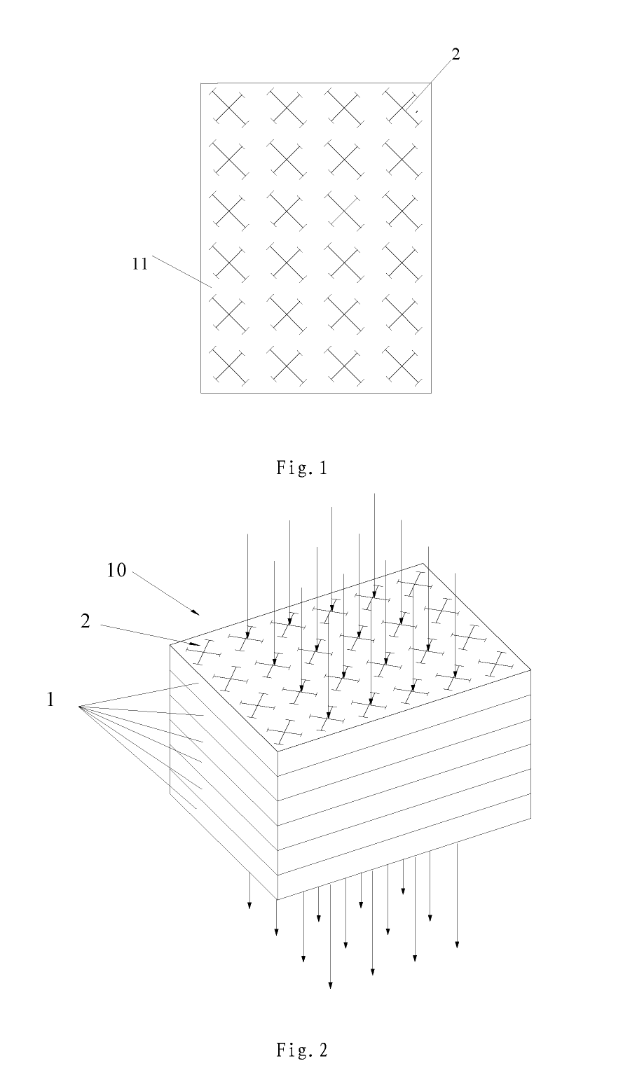

As shown in FIG. 1, FIG. 1 is a schematic view showing structure of sheet-like substrate 11 and a number of artificial microstructures 2 in an embodiment of polarization converter made of metamaterial. Base material 1 actually consists of a number of sheet-like substrates 11 stacked in a direction perpendicular to the page plane. Electromagnetic wave is also incident along a direction perpendicular to the page plane.

As shown in FIG. 2, FIG. 2 is another view seen from different perspective angle of FIG. 1. As an embodiment of the present invention, the base material 1 consists of a number of sheet-like substrates 11 stacked together and parallel to each other. Each sheet-like substrate 11 has a number of artificial microstructures 2 attached thereon. The sheets like substrates 11 are perpendicular to the incident direction of electromagnetic wave. All artificial microstructures are arranged periodically on the sheet-like substrate. It can be clearly seen that the base material 1 is a square object with a thickness made up of a number of sheet-like substrates 11 stacked together. In this figure, a number of arrows above the base material 1 represent incident electromagnetic waves, a number of arrows below the base material 1 represent emergent electromagnetic waves. Electromagnetic waves can be perpendicularly incident onto the plane where the artificial microstructures located. When the product is manufactured in practice, it can also be packaged so that the artificial microstructures cannot be visible from outside. The packaging material is the same as base material. Of course, in order to avoid damages caused by direct contact between artificial microstructures and sheet-like substrates, the space between each adjacent two sheet-like substrates can be filled with air or some other medium with dielectric constant and permeability close to that of air.

Continuing to refer to FIG. 1-2, the metal microstructures within the same plane are arranged in a 4*6 matrix and there are 6 layers (6 pieces of sheet-like substrates) arranged in the incident direction of electromagnetic wave. However, this is only a schematic representation. There can be different plane arrangements as demands and the arrangement of metal microstructures in the incident direction of electromagnetic wave can have other number of layers. For example, under the condition that the arrangement of metal microstructures in each plane is given, the thickness of the polarization converter made of metamaterial in the perpendicular incident direction can be controlled by the number of planes (the number of sheet-like substrates), thereby obtaining desired phase difference and achieving different polarization conversion.

Continuing to refer to FIG. 1-2, the polarization converter made of metamaterial 10 according to the present invention includes a base material 1 and a number of artificial microstructures 2 with anisotropic electromagnetic property disposed on the base material 1. A number of artificial microstructures 2 are uniformly distributed on one or more planes perpendicular to the incident direction of electromagnetic wave. The refractive indices within the polarization converter made of metamaterial 10 are uniformly distributed. Herein, the uniform distribution of refractive indices refers to the refractive index distributions at positions where each artificial microstructure located are the same. In addition, since the electromagnetic wave is incident perpendicularly, the propagation direction of the electromagnetic wave does not change when exiting. The electric field vector of incident electromagnetic wave can be decomposed into two non-zero orthogonal components at the above mentioned one or more planes. The two components can be parallel and perpendicular to the optical axis where the artificial microstructure located. Herein, optical axis refers to major axis of index ellipsoid of the artificial microstructure. Herein, index ellipsoid refers to spatial distribution of refractive indices of each artificial microstructure. The included angle between the optical axis and the electric field vector direction of electromagnetic wave cannot be 0, and thus both decomposed orthogonal components from the electric field vector in a plane perpendicular to the incident direction of electromagnetic wave are not zero. After the electromagnetic wave passing through the polarization converter made of metamaterial 10, the two orthogonal components have a phase difference Δθ different from that before incidence, Δθ=(k1−k2)×d, thereby achieving mutual conversion between the above electromagnetic wave polarization modes. Wherein

k1=ω×\sqrt{ε₁}×\sqrt{μ₁};

k2=ω×\sqrt{ε₂}×\sqrt{μ₂};

The ω is frequency of electromagnetic wave;

ε₁ and μ₁ are dielectric constant and permeability of the metamaterial unit in the direction of one of the two orthogonal components respectively. ε₂ and μ₂ are dielectric constant and permeability of the metamaterial unit in the direction of the other of the two orthogonal components respectively.

The d is the thickness of the metamaterial.

After exiting, the two orthogonal components can be combined to obtain an electric field vector (electric field vector of emergent electromagnetic wave), which is certainly different from the electric field vector of electromagnetic wave before incidence, thereby achieving polarization conversion between incident electromagnetic wave and emergent electromagnetic wave. The above-mentioned artificial microstructures generally refer to metal microstructures, such as metal wires. However, other artificial microstructures can also be used, as long as they can satisfy the condition that they have electric response to the two orthogonal components of the electric field vector of incident electromagnetic wave.

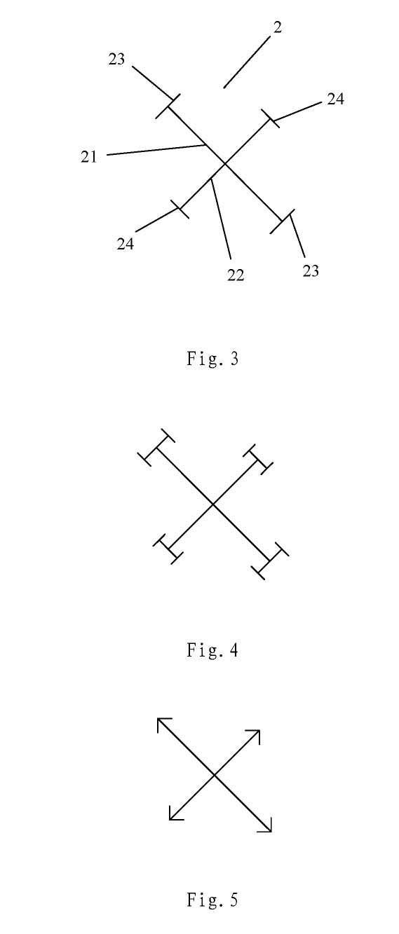

As shown in FIG. 3, as a specific embodiment, the wires are in the form of two dimensional snowflake shape which has a first main wire 21 and a second main wire 22 crossed perpendicularly to each other. Two first branch wires 23 are disposed perpendicularly at two ends of the first main wire 21. Two second branch wires 24 are disposed perpendicularly at two ends of the second main wire 22. The first main wire 21 and the second main wire 22 bisect each other. The centers of the two first branch wires 23 are connected to the first main wire 21. The centers of two second branch wires 24 are connected at the second main wire 22. However, the illustration is only schematic, in practice, the first main wire, the second main wire, the first branch wires and the second branch wires have width. In this embodiment, the situation for isotropy is that beside the above described characteristics, the wires should also satisfy the following two conditions:

1) the first main wire and the second main wire have the same length and width;

2) the first branches and the second branches also have the same length and width;

Therefore, if the above conditions are not satisfied concurrently, the unit structures constituted by the metal microstructures with the above described patterns exhibit anisotropic.

In this embodiment, the electric field vector of the incident electromagnetic wave is decomposed into two orthogonal components at a line where the first main wire 21 and the second main wire 22 located. That is to say, the direction of one of the first main wire 21 and the second main wire 22 is the direction of the optical axis. In this way, one of the two orthogonal components of the electric field vector of electromagnetic wave is in the direction of the line of the first main wire 21 and the other of the two orthogonal components of the electric field vector of electromagnetic wave is in the direction of the line of the second main wire 22 so that the metal microstructures 2 can influence (have electric field response to) both of the two orthogonal components of the electromagnetic wave. Alter superposition over a period, such influences will cause the two orthogonal components of the electric field vector to change phase difference. Thereby, the combined vector of the two orthogonal components (the electric vector of the emergent electromagnetic wave) will change, thereby achieving the polarization conversion of electromagnetic wave. When the electromagnetic wave in any polarization state is converted into linear polarization wave, the amplitudes of two components of electric field vector of the emergent electromagnetic wave can be equal or not equal. If equal, then mutual conversion between horizontal polarization and vertical polarization can be achieved. At this time, the included angle between the first main wire 21 and the electric field vector of the incident electromagnetic wave is 45 degrees. If the electromagnetic wave in any polarization state is converted into circular polarization wave, the amplitudes of two components of the electric field vector of emergent electromagnetic wave should also be equal. At this time, the included angle between the first main wire 2 and the electric field vector of the incident electromagnetic wave should also be 45 degrees. As shown in FIG. 4-6, the wires can have other patterns (or topological structure). FIG. 4 is a pattern derived from FIG. 3, i.e., two further branch wires are added at two ends of each of the two first branch wires and two second branch wires. Deriving in this way, there are plenty of further derived patterns. FIG. 5 to FIG. 6 are patterns derived from that shown in FIG. 3. There can be many other variations of patterns that will not be enumerated in detail herein. As an embodiment, the artificial microstructures are metal microstructures. Each of the metal microstructure is wires of certain pattern attached on the sheet-like substrate 11. The pattern or the wires is a non 90 degrees rotational symmetric graphic. Non 90 degrees rotational symmetric graphic is a relative concept to 90 degrees rotational symmetry. The so called 90 degrees rotational symmetry refers that after rotating 90 degrees in any direction along its symmetry center, a graphic can be coincident with the original graphic. Unit grid constituted by metal microstructures with such graphic can exhibit isotropy (i.e., at each point in the space of the unit grid, the electromagnetic parameter is the same). On the contrary, Unit grid constituted by metal microstructures with non 90 degrees rotational symmetric graphic can exhibit anisotropy (i.e., not each point in the space of the unit grid has the same electromagnetic parameter tensor). If the unit grid constituted by metal microstructure exhibits anisotropy, the electric field vector of the electromagnetic wave passing it will be influenced so that both of the two orthogonal components will be influenced when the electromagnetic wave passing through each unit grid. However, since the artificial microstructures have anisotropic electromagnetic property, the two orthogonal components are influenced differently. That is to say, the two orthogonal components vibrate at different rates, therefore the phase differences of the two orthogonal components change. When the electromagnetic wave exits the converter made of metamaterial, the phase differences caused by a number of unit grids which they passed through can be accumulated. If the final phase difference Δθ is not equal to the phase difference before incidence, then the electric field vector of the combined two orthogonal components (electric field vector of emergent electromagnetic wave) has changed polarization property change and polarization conversion can be achieved.

In practice, the entire polarization converter made of metamaterial (actually a kind of metamaterial) can be divided into several identical unit grids. Each unit grid includes an artificial microstructure and a substrate to which the artificial microstructure attached. The entire polarization converter made of metamaterial can be regarded as constituted by a number of such unit grids. Each unit grid can have electric field response and/or magnetic response to the electromagnetic wave passing through it. In other words, when the electromagnetic wave is passing through each unit grid, both of the two orthogonal components will be influenced. That is to say, the phase of the two orthogonal components will change. However, since the artificial microstructure has anisotropic electromagnetic property, the two orthogonal components can be influenced differently. That is to say, the two orthogonal components vibrate at different rates, therefore the changing magnitudes of the phase of the two orthogonal components changes are different. The phase difference of the two orthogonal components changes continuously. When the electromagnetic wave exits the converter made of metamaterial, the changes of the phase difference caused by a number of unit grids they passed through can be accumulated. If the final phase difference Δθ is different from the phase difference before incidence, then the electric field vector of the combined two orthogonal components (electric field vector of emergent electromagnetic wave) has changed polarization property and polarization conversion can be achieved. The anisotropic electromagnetic parameter of the artificial microstructures refers to not each point in the unit gird where the artificial microstructure located is not the same.

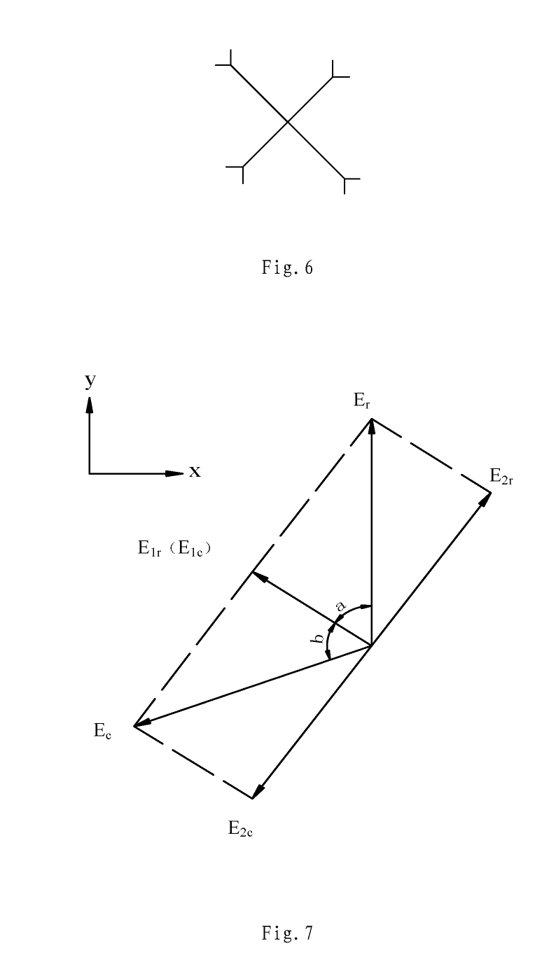

As shown in FIG. 7 which shows a schematic view of the polarization conversion of electromagnetic wave (in the plane defined by x axis and y axis), if the propagation direction of the electromagnetic wave is defined as z axis in three dimensional coordinate system, then according to basic principles of electromagnetic wave, the electric field vector E is in the plane defined by x axis and y axis. Assuming the electric field vector of incident electromagnetic wave is Er, its two orthogonal components are E1r and E2r. The electric field vector of the electromagnetic wave at the time exiting the polarization converter made of metamaterial is Ec, and its two orthogonal components are E1c and E2c. E1r represents the component along optical axis direction, and E2r represents the other component. E1c and E2c are two components of E1r and E2r when exiting. Herein, the assumption that Ec is the electric field vector of electromagnetic wave at the time exiting the polarization converter made of metamaterial is just for the convenience of description, because the polarization property of the electromagnetic wave has become stable after exiting the metamaterial and will not be influenced by the artificial microstructures. Assuming the included angle between Er and E1r before electromagnetic wave incidence is a, and just after the electromagnetic wave passing through the polarization converter, the component E1c of the electric field vector Ec of the electromagnetic wave are completely coincident with the component E1r, the included angle between Ec and E1c is b. The polarization conversion of the electromagnetic wave according to the present invention will be described under two situations.

(1) in mutual conversion between two linear polarized electromagnetic waves with any included angle, at this time Δθ=Kπ(K is integral number). The phase of combined electric field vector Ec of the two orthogonal components E1c and E2c is a constant, and the conversion from the electromagnetic wave in any polarized state to linear polarized electromagnetic wave can be achieved. As shown in FIG. 7, assuming it represents the conversion between two linear polarized electromagnetic waves with any included angles, because the phase difference between E1c and E2c is Kπ and E2c is located at the position shown in FIG. 7, according to geometrical principle, the norms of Ec and Er after combination are equal. The only difference is that Ec is rotated by an angle (a+b) in the plane defined y x axis and y axis. Similarly, according to geometrical principle, it can be deduced that a=b, i.e., Ec is rotated by an angle 2a in the plane defined by x axis and y axis. If the included angle between the optical axis direction of artificial microstructure and the electric field vector direction is 45 degrees (i.e., a=45 degrees), i.e., the included angle between Er and E1r is 45 degrees, then after passing through such polarization converter made of metamaterial, Ec is rotated by 90 degrees in the plane defined by x axis and y axis. Therefore, mutual conversion between horizontal polarization and vertical polarization (i.e., the electric field vector direction of incident electromagnetic wave is in the y axis direction or x axis direction) can be achieved by polarization converter made of metamaterial with such structure. If the included angle between the optical axis direction of artificial microstructures and the electric field vector direction is not 45 degrees (i.e., a does not equal to 45 degrees), then after passing through such polarization converter made of metamaterial, Ec is rotated by an angle 2a (which is not 90 degrees) in the plane defined by x axis and y axis. Therefore, conversion between horizontal polarization and another horizontal polarization, or vertical polarization and another vertical polarization can be realized.

(2) conversion between linear polarized electromagnetic wave to non linear polarized electromagnetic wave. At this time, Δθ does not equal to Kπ, wherein k is integral number. This can be classified into two situations:

The first situation. In order to realize mutual conversion between linear polarized electromagnetic wave and circular polarized electromagnetic wave, Δθ=(2K+1) (π/2) and the included angle between the optical axis direction of artificial microstructure and the electric field vector direction of incident electromagnetic wave should be 45 degrees. That is to say, the included angle between electric field vector Er and E1r of incident electromagnetic wave is 45 degrees. Assuming FIG. 7 shows the mutual conversion between linear polarized electromagnetic wave and circular polarized electromagnetic wave, then if a equals to 45 degrees, according to geometrical principle, at this time, the amplitudes of E1r and E2r are the same. Therefore, the amplitudes of two orthogonal components E1c and E2c of electric field vector Ec of emergent electromagnetic wave are also equal. The amplitudes of two orthogonal components E1c and E2c are equal and their phase difference is Δθ=(2K+1) (π/2). As a result, as seen from propagation direction, the vector endpoint of the emergent electromagnetic wave appears to meet on a circle, and then such emergent electromagnetic wave is circular polarization wave. Consequently, mutual conversion between linear polarized electromagnetic wave and circular polarized electromagnetic wave can be realized. Levorotation or dextrorotation of circular polarization depends on which of E1c and E2c will go ahead. If E1c is ahead of E2c (π/2), then it will be dextrorotation circular polarization. If E1c lags behind E2c (π/2), then it will be levorotation circular polarization.

The second situation. In order to realize mutual conversion between linear polarized electromagnetic wave and elliptical polarized electromagnetic wave, Δθ is not equal to Kπ and not equal to (2K+1) (π/2). The included angle between the optical axis direction of artificial microstructure and the electric field vector direction of incident electromagnetic wave is not equal to 45 degrees. That is to say, the included angle between the electric field vectors Er and E1r of incident electromagnetic wave is not 45 degrees. Assuming FIG. 7 is a schematic view showing mutual conversion between linear polarized electromagnetic wave and elliptical polarized electromagnetic wave. If a is not equal to 45 degrees, then according to geometrical principle, the amplitudes of E1r and E2r are not equal. Therefore, the amplitudes of two orthogonal components E1c and E2c of electric field vector Ec of emergent electromagnetic wave are not equal either. The amplitudes of two orthogonal components E1c and E2c are not equal and their phase difference Δθ is not equal to (2K+1) (π/2) nor Kπ. Therefore, as seen from the propagation direction, the vector endpoint of emergent electromagnetic wave appear to meet on a ellipse, the emergent electromagnetic wave is elliptical polarized wave. Thereby, mutual conversion between linear polarized electromagnetic wave and elliptical polarized electromagnetic wave can be realized. Levorotation or dextrorotation of circular polarization depends on which of E1c and E2c will go ahead. If E1c is ahead of E2c (π/2), then it will be dextrorotation elliptical polarization. If E1c lags behind E2c (π/2), then it will be levorotation elliptical polarization.

It is noted that each phase difference corresponds to a class (not one) polarization converter made of metamaterials. The function of certain polarization converter made of metamaterial is singular, because the polarization properties of incident electromagnetic waves are different. Although two orthogonal components of electric field vector of emergent electromagnetic wave have identical phase difference, polarization converter made of metamaterial can have different influences to different incident electromagnetic waves. They can be regarded as passing through different polarization converters.

Artificial microstructures generally employ metal microstructures. Under the condition that the polarization property of incident electromagnetic wave is given, polarization converter made of metamaterial can be designed according to the desired polarization property of emergent electromagnetic wave. For example, materials for base material and metal microstructure are selected first, then patterns, designed size of metal microstructures and/or the arrangement of metal microstructures in space can be changed in order to obtain desired phase difference Δθ. This is because electromagnetic parameters ε and μ of each unit grid in the space of polarization converter made of metamaterial can be changed by changing patterns, designed size of metal microstructures and/or the arrangement of metal microstructures in space, thereby changing the refractive index n of respective unit grid. The polarization converter made of metamaterial can be regarded as made up of a number of such unit grids. Thereby, by reasonably calculating the desired obtainable Δθ, desired polarization conversion can be achieved. There are plenty of ways to obtain patterns, designed size of metal microstructures and/or the arrangement of metal microstructures in space. For example, they can be obtained by reverse computer analogue stimulation. First the numerical value of Δθ is determined. Then general electromagnetic parameter distribution of the polarization converter made of metamaterial is designed according to this numerical value. Then the electromagnetic parameter distribution of each unit grid can be calculated from the general distribution. Then, patterns, designed size of respective metal microstructures and/or the arrangement of metal microstructures in space can be selected according to the electromagnetic parameter of each unit grid (computer can store plenty of data about a variety of metal microstructures beforehand). Each unit grid can be designed by exhaustion method. First, a metal microstructure with certain pattern is selected, and electromagnetic parameter is calculated. Compare the obtained result and the desired result, and repeat the comparison many times until find the desired electromagnetic parameter. If find, the selection of design parameter is finished. If not, the above process will not end. That is to say, the process will not end until metal microstructure with desired electromagnetic parameter is found. Since the process is conducted by computer, though seems complicated, it can be quickly finished.

As an embodiment, the wires can attach to the sheet-like substrate 11 by means of etching, electroplating, drilling, photoengraving, electronic engraving or ion engraving.

The sheet-like substrate 11 can be made of materials such as ceramic materials, polymer materials, ferroelectric materials, ferrite materials or ferromagnetic materials. It can also be made of epoxy resin or polytetrafluoroethylene. As an embodiment, the sheet-like substrate is made of polytetrafluoroethylene. Polytetrafluoroethylene has great electrical insulation so it will not cause any interference to the electric field of the electromagnetic wave and it also has excellent chemical stability and corrosion resistance and long useful life. Therefore, it is a good choice to use as base material to which the metal microstructures can be attached.

As an embodiment, the wire is copper wire or silver wire. Copper and silver have good electrical conductivity and have very sensitive response to electric field.

The embodiments of the present invention have been described above with reference to the attached drawings; however, the present invention is not limited to the aforesaid embodiments, and these embodiments are only illustrative but are not intended to limit the present invention. Those of ordinary skill in the art may further devise many other implementations according to the teachings of the present invention without departing from the spirits and the scope claimed in the claims of the present invention, and all of the implementations shall fall within the scope of the present disclosure.

What is claimed is:

1. A polarization converter made of metamaterial, characterized in that, the polarization converter made of metamaterial including a base material and a number of artificial microstructures disposed on the base material,
wherein the artificial microstructures can influence the electric field vector of plane electromagnetic wave propagating in it, the electric field vector of the electromagnetic wave can be decomposed into two non-zero orthogonal components on one or more planes perpendicular to the incident direction of the electromagnetic wave,
wherein the two orthogonal components can be parallel and perpendicular to the optical axis at the position where the artificial microstructure located respectively;
after the electromagnetic wave passing through the polarization converter made of metamaterial, the two orthogonal components have a phase difference Δθ different from that before incidence, thereby achieving mutual conversion between the above electromagnetic wave polarization modes.

2. The polarization converter made of metamaterial according to claim 1, characterized in that,
the electromagnetic properties of the number of artificial microstructures are anisotropic;
the refractive indices in the polarization converter made of metamaterial are distributed uniformly;
the number of artificial microstructures are uniformly distributed on one or more planes perpendicular to the incident direction of the electromagnetic wave.

3. The polarization converter made of metamaterial according to claim 1, characterized in that, the phase difference Δθ=(k1−k2)×d, wherein
k1=ω×\sqrt{ε₁}×\sqrt{μ₁};
k2=ω×\sqrt{ε₂}×\sqrt{μ₂};
The ω is frequency of electromagnetic wave;
ε₁ and μ₁ are dielectric constant and permeability of the metamaterial unit in the direction of one of the two orthogonal components respectively;
ε₂ and μ₂ are dielectric constant and permeability of the metamaterial unit in the direction of the other of the two orthogonal components respectively,
The d is the thickness of the metamaterial.

4. The polarization converter made of metamaterial according to claim 1, characterized in that,
the base material is made up of a number of sheet-like substrates stacked together and parallel to each other;
each of the sheet-like substrates has a number of artificial microstructures attached thereon;
the sheet-like substrate is perpendicular to the incident direction of the electromagnetic wave,
all of the artificial microstructures are arranged periodically on the sheet-like substrate.

5. The polarization converter made of metamaterial according to claim 4, characterized in that, the substrate can be made of ceramic, polymer materials, ferroelectric materials, ferrite materials or ferromagnetic materials.

6. The polarization converter made of metamaterial according to claim 1, characterized in that, the phase difference Δθ=Kπ, wherein K is integral number.

7. The polarization converter made of metamaterial according to claim 6, characterized in that, the optical axis direction of the artificial microstructure and the electric field vector direction of the incident electromagnetic wave include an angle of 45 degrees.

8. The polarization converter made of metamaterial according to claim 6, characterized in that, the optical axis direction of the artificial microstructure and the electric field vector direction of the incident electromagnetic wave include a non 45 degrees angle.

9. The polarization converter made of metamaterial according to claim 1, characterized in that, the phase difference Δθ=(2K+1) (π/2), wherein K is integral number.

10. The polarization converter made of metamaterial according to claim 9, characterized in that, the optical axis direction of the artificial microstructure and the electric field vector direction of the incident electromagnetic wave include an angle of 45 degrees.

11. The polarization converter made of metamaterial according to claim 1, characterized in that, the phase difference Δθ is not equal to Kπ and not equal to (2K+1) (π/2), wherein K is integral number.

12. The polarization converter made of metamaterial according to claim 11, characterized in that, the optical axis direction of the artificial microstructure and the electric field vector direction of the incident electromagnetic wave include a non 45 degrees angle.

13. The polarization converter made of metamaterial according to claim 1, characterized in that, the artificial microstructures are metal microstructures, wherein each metal microstructure is wires of certain pattern attached to the sheet-like substrate, the pattern of the wires is a non 90 degrees rotational symmetric graphic.

14. The polarization converter made of metamaterial according to claim 13, characterized in that, the wires can attach to the substrate by means of etching, electroplating, drilling, photoengraving, electronic engraving or ion engraving.

15. The polarization converter made of metamaterial according to claim 13, characterized in that, the wires are copper wire or silver wire.

16. The polarization converter made of metamaterial according to claim 13, characterized in that,
the wires are in the form of two dimensional snowflake shape which has a first main wire and a second main wire crossed perpendicularly to each other,
wherein two first branch wires are disposed at two ends of the first main wire, two second branch wires are disposed at two ends of the second main wire.

17. The polarization converter made of metamaterial according to claim 16, characterized in that, the first main wire and the second main wire bisect each other, wherein the centers of the two first branch wires are connected to the first main wire, the centers of two second branch wires are connected at the second main wires.

18. The polarization converter made of metamaterial according to claim 17, characterized in that, the electric field vector of incident electromagnetic wave is decomposed into two orthogonal components at the line where the first main wire and the second main wire located.

19. The polarization converter made of metamaterial according to claim 18, characterized in that, the electric field vector direction of the incident electromagnetic wave and the first main wire include an angle of 45 degrees.
